(19) United States
(12) Patent Application Publication
(10) Pub. No.: US 2012/0146784 A1
(43) Pub. Date: Jun. 14, 2012

(54) Protective Fabrics and Garments

(76) Inventors: Robert Winfred Hines, Columbus, GA (US); Leslie Gene Cone, Columbus, GA (US)

(21) Appl. No.: 13/380,548

(22) PCT Filed: Jun. 28, 2010
(86) PCT No.: PCT/US2010/040146

§ 371 Date: Mar. 5, 2012

Related U.S. Application Data
(60) Provisional application No. 61/221,268, filed on Jun. 29, 2009.

(51) Int. Cl. G08B 1/08; D04B 1/14; A41D 7/00; A41D 1/00; F41H 1/02

(52) U.S. Cl. 340/539.11; 2/69; 2/2.5; 2/67; 442/308

(57) ABSTRACT

Fabrics with a knit construction using an air jet spun yarn and ring spun yarn that provide electric arc protection are disclosed. Garments made from the fabrics are also disclosed. In addition, devices, systems, and methods are disclosed that are useful for tracking for the purpose of monitoring and alerting the user of a garment and/or others regarding the safety, health, environmental, and security aspects of the garment, user, and/or the environment in which the user is present.

### CROSS REFERENCE TO RELATED APPLICATIONS

This application claims priority to U.S. Application No. 61/221,268 filed Jun. 29, 2009, the entire disclosure of which is incorporated by reference.

### FIELD OF THE INVENTION

The present invention generally relates to protective fabrics and garments, and to systems and methods of employing the protective garments to ensure safety, health, environmental, and security compliance. More particularly, the invention relates to fabrics with a knit construction that provides electric arc protection, preferably with good visibility. Further aspects include related devices, systems, and methods that are useful for tracking for the purpose of monitoring and alerting the user of a garment and/or others regarding the safety, health, environmental, and security aspects of the garment, user, and/or the environment in which the user is present.

### BACKGROUND OF THE INVENTION

### Electrical and Thermal Discharge Hazards

Workers attending to electrical utility lines and related equipment are exposed to the risk of electrical arc flash hazards. Their work wear must provide adequate protection. In particular, electrical utility linemen, industrial electricians, electrical contractors, and electrical service personnel are routinely exposed to the momentary electric arc flash and its related thermal hazards. As a consequence, many workers have been electrocuted, burned, or severely injured.

An arc flash is the explosive release of energy caused by the passage of electrical current between two electrodes through ionized gases or plasma, characterized by a temperature reaching several thousands degrees Centigrade. As workers perform their tasks on or near energized wire systems or circuitry, an arc flash may occur as a result of their inadvertent movement, accidental contact, or some equipment failure. The electrical energy supplied in the forming arc is converted into an explosive fireball-like phenomenon that is likely to impact or even envelop the worker. The resultant explosive effect of the arc produces intense thermal radiation, noise, melting, and even vaporization of metal components of the equipment around the arc. Depending upon the severity of the arc flash, burns will occur on bare or unprotected skin. Also, if the worker is wearing non-flame retardant clothing, the arc is likely to ignite it.

Thus, to provide a safer workplace for the utility workers, the National Fire Prevention Association (NFPA) has issued a standard NFPA 70 E-2000 for electrical safety requirements. The standard calls for protective clothing to be tested and rated to the level of the arc flash energy hazards to which the electricity workers could be exposed.

In addition to the dangers posed by electrical arc discharge, utility workers are also exposed to thermal hazards from the heat of the flash fires caused by ignited gas, combustible vapors, volatile solvents, and/or chemical dust. Flash fires are defined by NFPA 2113 as those lasting no more than three seconds.

Thermal performance of garments is covered by the American Society for Testing Materials (ASTM) Test F 1959, which uses the electric arc to determine the number of calories required to create second degree burns in terms of calories per square cm. There is also an ASTM F 1506 standard for clothing worn around electric arc hazards.

Yet another consideration in the production of utility workers' protective garments is the hazard of static electricity spark discharge. Such discharge is likely to ignite a flash fire of the kind mentioned above. Static electricity charges of several thousands volts may be generated simply by rubbing one part of the garment against another or against a car seat or a plastic object. These charges can create a spark of sufficient length to ignite gas, fuel vapors, solvents, and the like, thus causing a flash fire.

Yet a further hazard to utility workers is when they come close to high tension equipment, such as transformers, switchgear, overhead wires, and like and are exposed to the corona discharge. Such discharge occurs from electrodes with sharp points or angles. It is due to the ionization of the air surrounding these points, which makes possible the escape of electrical energy through the air. Corona discharge takes the form of luminous glow; the higher the voltage the more intense the corona discharge. Corona discharge can be hazardous to utility workers servicing high tension installations where the coronal discharge may induce dangerous levels of electrical energy flux in the workers apparel.

At the present time, protective garments are made with densely woven, heavy fabrics using flame resistant fibers such as modacrylic, p-aramid sold under the trademark KEVLAR, m-aramid sold under the trademark NOMEX, polybenzimidazole (PBI), fire resistant (FR) rayon, and others. These fibers not only must withstand the very high arc temperature for a brief span of time, but must also be resistant to melting and dripping, which can cause severe burns. A frequently used fiber in garments is modacrylic spun into medium count yarns. Modacrylics are the copolymers of acrylonitrile fibers, which are very difficult to ignite and have self extinguishing properties. These fibers also have good weathering properties, resistance to acids, alkalis, and a wide range of chemicals. Their dielectric strength exceeds 1500 volts per mil of plastic film, which constitutes an important consideration in electrical applications.

A distinct advantage of modacrylic yarns is their relatively moderate price in comparison with other types of yarns available on the market. Modacrylics feature also superior processability during manufacture.

Nonetheless, woven fabrics incorporating flame resistant fibers and used in making electric arc protective garments are less than desirable. In the first place, since woven fabrics must be dense and tightly constructed in order to preserve their structural integrity, they have reduced porosity properties, resulting in reduced wearing comfort. In a warm environment, for example, garments made with such fabrics may feel excessively hot and clammy. The consequence being that some workers avoid wearing them altogether. Also, relative stiffness of woven fabrics and the lack of any “give” encumber the freedom of movement of the garment wearer.

In addition, weaving is essentially a slow process and generally limited to narrow width fabrics. This causes wovens to be relatively expensive in comparison with other fabricating systems like warp and weft knitting.

Furthermore, woven fabrics have a propensity to distort, rip, and fray. Because the yarn components of warp and weft are held in the structure by frictional forces only, there is a tendency for them to slip on each other and distort the fabric in forming cracks and open areas on its face. In that regard, the peculiar geometry and interlacing of the yarn components of woven fabrics renders them susceptible to ripping. Thus, even a minor cut or puncture in the garment caused by a sharp part of the equipment can propagate itself into a long tear or rip, thereby destroying the garment.

A related problem with woven garments is seam failure. This may be caused by the problem of fraying of the threads from a cut edge of the fabric. This may produce seam failure due to the individual fabric threads “combing out” from the seamed edge. Seam failure may have serious consequences in that it could allow the heat flux of the electric arc to penetrate inside a protective garment so as to cause burns to its wearer.

### Visibility Hazards

In addition to the issues caused by electrical hazards, there are issues relating to personnel work wear and insufficient conspicuity. Personnel employed in all modes of traffic control, utility and survey work, emergency response, construction, equipment operation, and vehicle roadway traffic are exposed to accident hazards due to insufficient conspicuity of ordinary workwear worn by them. These hazards are due to the workers' low visibility, which are intensified by the often complex and varying backgrounds of the above mentioned occupations and job assignments.

A major hazard issue involves situations in which objects can be visible, but are not consciously recognized by the vehicle driver within sufficient time to take corrective action in order to avoid an accident. This conscience recognition is often influenced by the level of task activities, varying daytime or nighttime lighting conditions, the complexity of backgrounds, vehicle speed, and the visual performance of the operator. Thus, worker safety is compromised by insufficient decision/reaction time resulting from the use of workwear not designed to provide sufficient visibility. It is thus important that workers are readily perceived by drivers when, for example, directing traffic, operating equipment, digging roadside trenches and doing maintenance work.

In order to reduce hazards to which the workers are exposed in performance of their tasks, special high visibility garments are available for their protection. These are covered by the requirements of both the American National Standard Institute (ANSI) and the Safety Equipment Association (ISEA). The garments may take the form of a coverall, jacket, vest, trousers, harness/sash belt, and others, depending on the work performed by the wearer.

Fluorescent dyed materials emit optical radiation at wavelengths longer than absorbed. They enhance daytime visibility, especially during dawn and dusk. Accordingly, garments may be provided with strips of retroreflective material placed in appropriate locations in order to enhance their conspicuity. Such retroreflective materials have the property of returning light to its source.

Garments instead may be made with a fabric dyed with one of three approved fluorescent colors; such colors are intended to be highly conspicuous to ensure visibility against most backgrounds found in urban and rural situations. The three colors are: yellow-green, orange-red and red. The chromaticity (the x and y coordinates) and the minimum luminance factor are stipulated by ISEA standards, as are all the fabric parameters applicable to the fabric. Performance requirements of garments must be tested and verified for conformance with these standards by an accredited testing lab.

Fabrics currently in use in high visibility garments are of the woven type. While such fabrics are adequate in performance, they leave much to be desired in wearing comfort, durability, and economics. Particularly, woven fabrics are, by their nature, tightly configured in their system of warp and filling threads. This limits the air permeability and hence the comfort factor, which is of a particular importance for workers exposed to the sun for prolonged periods of time.

Woven fabrics that meet the ISEA performance requirements are relatively stiff and, therefore, to some extent, inhibit the garment wearer's freedom of movement. Also, woven fabrics are prone to ripping, tearing, and fraying. This limits the useful life of the garment, which suffers much physical stress when worn at high rough work sites. Finally, there is the question of economics. Woven fabrics that meet the ISEA standards are relatively expensive due to the cost of suitable yarns and the involved processing cycles.

### Smart Garments

Certain individuals work in dangerous environments by the very nature of their work. Examples include, but are not limited to, utility workers being exposed to electrical and fire hazards, fire fighters being exposed to fire and explosive hazards, police and military personnel being exposed to ballistic hazards, and industrial and oil exploration and refining workers being exposed to chemical, biological, electrical, explosive, and/or radiation hazards. Each of these types of workers wears special protective garment and equipment to minimize or eliminate the hazards to which they are exposed. However, it is difficult to properly track the use or misuse of the garments and protective equipment. Accordingly, it would be desirable to have a garment that could be tracked individually for a particular individual in a particular environment.

RFID tags have been used to track garments. For example, U.S. Pat. No. 5,785,181 discloses the use of a permanent RFID tag having a unique number, applied to a garment during a visit to a dry cleaner, to track a garment over its life. Information related to the garment (such as owner name, dates reasons for cleaning, etc.) is input to a computer along with the identification number. Each time the garment is deposited with a dry cleaner the RFID tag is automatically read by a tag reader, and information related to the current visit is input to the computer. U.S. Pat. No. 7,195,165 discloses a system and method for using machine-readable technology to uniquely identify garments and to associate the uniquely identified garments with particular users.

RFID tags have been used to track a body's bio-readings and environmental information. For example, U.S. Pat. No. 7,463,142 discloses the use of bio-reading sensors used in combination with technology for receiving information from electronic tags associated with items in a body's environment.

Accordingly, it would be desirable to provide a fabric or garment that overcomes the above disadvantages related to electric arc protection and visibility. There also exists a need to use machine-readable tracking technology to uniquely identify garments and to associate the garment with a particular user in a particular environment to monitor and ensure safety, health, environmental, and/or safety compliance. The fabrics, garments, systems, and methods of the present invention are directed toward these, as well as other, important ends.

### SUMMARY OF THE INVENTION

The invention relates generally to protective fabrics. More particularly, the invention relates to fabrics with a knit construction that provides electric arc protection of at least arc hazard exposure level 2 protection, preferably with good visibility.

Accordingly, in one embodiment, the invention is directed to knitted fabrics, comprising:

a first portion comprising a yarn selected from the group consisting of air jet spun yarn, ring spun yarn, and SIRO yarn; and

a second portion comprising a yarn selected from the group consisting of ring spun yarn and SIRO yarn;

wherein said second portion comprises no more than about 5% by weight, based on the total weight of the first portion, of a thermoplastic fiber (such as polyester and/or nylon) that melts when exposed to an open flame;

wherein said first portion and said second portion are configured in a double knit with a tie yarn; and

wherein said knitted fabric has a basis weight of at least about 6.0 ounces/square yard (OPSY).

In another embodiment, the invention is directed to garments, comprising the fabric described herein;

wherein said first portion forms the outside of said garment; and

wherein said second portion forms the inside of said garment.

The invention relates generally to devices, systems, and methods that are useful for tracking at least one garment for the purpose of monitoring and alerting the user of the garment and/or others regarding the safety, health, environmental, and security aspects of the garment, user, and/or the environment in which the user is present.

Accordingly, in yet other embodiments, the invention is directed to garments,

comprising:

fabric;

at least one traceable marker memory device in contact with said fabric; and

optionally, at least one sensor;

wherein said traceable marker memory device comprises information selected from the group consisting of identity of said garment, time in/out of a user, elapsed time from a triggering event, physiological characteristic of a user, environmental condition of a user, exposure level of a user, service life of said garment, compliance level of said user, and combinations thereof.

In another embodiment, the invention is directed to systems, comprising:

at least one garment described herein; and

a detector for the traceable marker memory device.

In certain systems, the system comprises a detector for the optional sensor.

In other embodiments, the invention is directed to methods of confirming adherence to a safety, health, environmental, or security standard of a user of a garment, comprising:

providing at least one garment, comprising:

fabric; and

at least one traceable marker memory device in contact with said fabric;

wherein said traceable marker comprises information selected from the group consisting of identity of a user, identity of said garment, time in/out of a user, elapsed time from a triggering event, global positioning of a user, physiological characteristic of a user, environmental condition of a user, exposure level of a user, service life of said garment, compliance level of said user, and combinations thereof;

reading said traceable marker to provide usage information;

determining whether usage information falls outside of at least one criterion for use of said garment; and

optionally, alerting said user or the supervisor of said user or both that said garment falls outside of at least one criteria for use of said garment.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an exemplary embodiment of a garment.

FIG. 2 illustrates a traceable marker memory device (bar code and magnetic tag) according to an exemplary embodiment of the invention.

FIG. 3 illustrates a garment having a traceable marker memory device thereon according to an exemplary embodiment of the invention.

FIG. 4 illustrates a garment tracking system according to an exemplary embodiment of the invention.

FIG. 5 illustrates a traceable marker memory device (RFID tag) according to an exemplary embodiment of the invention.

FIG. 6 illustrates an in-use detector device according to an exemplary embodiment of the invention.

### DETAILED DESCRIPTION OF THE INVENTION

As employed above and throughout the disclosure, the following terms, unless otherwise indicated, shall be understood to have the following meanings

As used herein, the singular forms “a,” “an,” and “the” include the plural reference unless the context clearly indicates otherwise.

As used herein, the term “about,” when referring to a measurable value such as an amount, a temporal duration, and the like, is meant to encompass variations of ±20%, preferably ±10%, more preferably ±5%, even more preferably ±1%, and yet even more preferably ±0.1% from the specified value, as such variations are appropriate to perform the disclosed methods.

As used herein, the term “arc” refers to the passage of a substantial electrical current through ionized air and gases. As used herein, the term “arc rating” refers to the maximum incident energy resistance demonstrated by a material prior to breakopen or at the onset of a second degree burn. As used herein, the term “arc hazard exposure level” is the classification of the maximum energy when exposed to an arc hazard:

| | |
|---|---|
| Category 1 | 4 calories/cm² |
| Category 2 | 8 calories/cm² |
| Category 3 | 25 calories/cm² |
| Category 4 | 40 calories/cm² |

The arc hazard exposure level may be measured E_{BT} or Arc Thermal Performance Value (ATPV).

As used herein, the term “modacrylic fiber” refers to an acrylic synthetic fiber made from a polymer comprising primarily residues of acrylonitrile. Modacrylic fibers are spun from an extensive range of copolymers of acrylonitrile. The modacrylic fiber may contain the residues of other monomers, including vinyl monomer, especially halogen-containing vinyl monomers, such as but not limited to vinyl chloride, vinylidene chloride, vinyl bromide, vinylidene bromide, and the like. The types of modacrylic fibers that can be produced within this broad category are capable of wide variation in properties, depending on their composition. Some examples of commonly available modacrylics are PROTEX™, KANEKALON™, and KANECARON™ by Kaneka Corporation, PYROTEX™, and Formosa Plastics.

As used herein, the term “aramid fiber” refers to a manufactured fiber in which the fiber-forming substance is a long-chain synthetic polyamide in which at least 85% of the amide linkages, (—CO—NH—), are attached directly to two aromatic rings.

As used herein, the term “basis weight” refers to a measure of the weight of a fabric per unit area. Typical units include ounces per square yard and grams per square meter.

As used herein, the term “garment” refers to any article of clothing or clothing accessory worn by a person, including, but not limited to shirt, pants, underwear, outer wear, footwear, headwear, swimwear, belts, gloves, headbands, and wristbands, especially those used as protective wear or gear.

As used herein, the term “linen” (when not referring to the hydrophilic fiber) refers to any article used to cover a worker or seating equipment used by workers, including, but not limited to sheets, blankets, upholstery covering, vehicle upholstery covering, and mattress covering.

As used herein, “double knit” means a knit fabric having two inseparable layers of loops, where each yarn forms loops that appear on both faces of the fabric. The term “double knit” includes both rib double knit and interlock double knit. A double-knit fabric may be produced on a circular-knitting machine equipped with two sets of latch needles situated at right angles to each other, which is well-known in the knitting and textile industries.

As used herein, “traceable marker memory device” is any device having machine-readable data encoded (embedded microprocessor and/or memory) on physical media, including but not limited to radio frequency identification (RFID) tags, optical codes (bar codes, or any numerical, textual, or graphical codes), global positioning systems (gps) chips, smart labels, magnetic tags, or other intelligent information coding. Suitable traceable marker memory devices also include two-dimensional encrypted, steganographic symbology from InfoGlyph.

Accordingly, in one embodiment, the invention is directed to knitted fabrics, comprising:

a first portion comprising a yarn selected from the group consisting of air jet spun yarn, ring spun yarn, and SIRO yarn; and

a second portion comprising a yarn selected from the group consisting of ring spun yarn and SIRO yarn;

wherein said second portion comprises no more than about 5% by weight, based on the total weight of the first portion, of a thermoplastic fiber (such as polyester or nylon) that melts when exposed to an open flame;

wherein said first portion and said second portion are configured in a double knit with a tie yarn; and

wherein said knitted fabric has a basis weight of at least about 6.0 ounces/square yard (OPSY).

It has been discovered that single knit fabrics do not provide sufficient protection to achieve at least arc hazard exposure level 2 protection. It has also been discovered that a basis weight of less than about 6.0 ounces/square yard does not provide sufficient protection to achieve at least arc hazard exposure level 2 protection. Preferably, the second portion contains substantially free (i.e., less than about 5% by weight, more preferably, less than about 2% by weight, even more preferably, less than about 1% by weight, and yet even more preferably none) of thermoplastic fiber that melts when exposed to an open flame.

In certain preferred embodiments, the first portion comprises air jet spun yarn. In certain preferred embodiments, the second portion comprises ring spun yarn.

In a preferred embodiment of the knitted fabrics,

the first portion comprises air jet spun yarn, wherein said air jet spun yarn comprises:
about 80-90%, by weight, based on the total weight of said air jet spun yarn, of at least one hydrophobic fiber;
about 5-15%, by weight, based on the total weight of said air jet spun yarn, of at least one hydrophilic fiber; and
about 0-15%, by weight, based on the total weight of said air jet spun yarn, of at least one aramid fiber; and
   the second portion comprises the ring spun yarn, wherein said ring spun yarn comprises:
about 80-90%, by weight, based on the total weight of said ring spun yarn, of at least one hydrophobic fiber; and
about 10-15%, by weight, based on the total weight of said ring spun yarn of at least hydrophilic fiber; and
about 0-15%, by weight, based on the total weight of said ring jet spun yarn, of at least one aramid fiber.
   The knitted fabric of this embodiment exhibit superior moisture management properties, such as those described in U.S. Pat. No. 5,888,914, the entire contents of which are incorporated herein by reference.

In certain preferred embodiments, the first portion comprises air jet spun yarn, especially where the air jet spun yarn is Murata spun yarn, including air jet and vortex spun yarn.

In certain embodiments, the first portion comprises air jet spun yarn. In other embodiments, the first portion comprises air jet spun yarn, said air jet spun yarn comprising:
about 80-90%, by weight, based on the total weight of said air jet spun yarn, of at least one hydrophobic fiber;
about 10-15%, by weight, based on the total weight of said air jet spun yarn, of at least one hydrophilic fiber; and
about 0-15%, by weight, based on the total weight of said air jet spun yarn, of at least one aramid fiber.
   In certain preferred embodiments, the air jet spun yarn comprises:
about 85-90%, by weight, based on the total weight of said air jet spun yarn, of at least one hydrophobic fiber;
about 10-15%, by weight, based on the total weight of said air jet spun yarn, of at least one hydrophilic fiber; and
about 0-10%, by weight, based on the total weight of said air jet spun yarn, of at least one aramid fiber.

In certain embodiments, the ring spun yarn comprises:
about 80-90%, by weight, based on the total weight of said ring spun yarn, of at least one hydrophobic fiber; and
about 10-15%, by weight, based on the total weight of said ring spun yarn of at least hydrophilic fiber; and
about 0-15%, by weight, based on the total weight of said ring jet spun yarn, of at least one aramid fiber.
   In certain preferred embodiments, the ring spun yarn comprises:
about 85-90%, by weight, based on the total weight of said ring spun yarn, of at least one hydrophobic fiber;
about 10-15%, by weight, based on the total weight of said ring spun yarn, of at least one hydrophilic fiber; and
about 0-10%, by weight, based on the total weight of said ring spun yarn, of at least one aramid fiber.

Suitable hydrophobic fibers include at least one polymer selected from the group consisting of polypropylene, polyethyleneterephthalate, nylon, polyacrylonitrile, polybenzimidazole (PBI), fluoropolymer, and copolymers thereof, and combinations thereof. Preferably, the hydrophobic fiber comprises polyacrylonitrile or copolymer thereof. More preferably, the hydrophobic fiber is modacrylic fiber or modacrylic copolymer fiber.

The choice of modacrylic fibers or yarns for application in the fabric material of the invention is based on their excellent fire retardancy performance combined with their non-melt, non-drip and self-extinguishing properties. These are critically important attributes in many working environments. If sufficiently high temperatures are reached on exposure to fire or explosion, a garment made with the inventive fabric will just carbonize by forming a protective charred barrier. This prevents propagation of flames, thereby protecting the wearer from severe burn injuries.

Modacrylics have a high so-called LOI value as compared with other fibers. The LOI represents the minimum oxygen concentration of an O₂/N₂ mix required to sustain combustion of a material. The LOI is determined by the ASTM Test D 2862-77. Modacrylics have an LOI value preferably between about 28 and 41 while conventional thermoplastic fibers have a much lower value of about 20 to 22.

Additionally, a very important aspect of wearing comfort is the so-called “moisture management” factor. This is often represented as the moisture vapor transport index of MVT, which reflects the efficiency in which a fabric moves perspiration away from the skin or underlying garment and causes it to evaporate into the ambient atmosphere. The MVT of the modacrylics used in the inventive fabric is approximately 2500 g/meter squared/24 hours ASTM E 96.

Modacrylic fibers used in the inventive fabric preferably have a tenacity of up to about 2.8 grams/denier, an elongation at break of between about 35% and about 40%, and a fusing temperature of between about 371° F. and about 410° F. The modacrylic fibers used in the inventive fabric also have a moisture regain (the amount of water by weight held by the fiber under controlled atmospheric conditions) of between about 0.4 and 4.0%.

Modacrylic fibers and yarns are moderately priced as compared with other materials of good thermal performance. They are readily available in the industry; they have good knitting performance, ease of fabric processing, and dyeing.

A significant attribute of modacrylics is their charring on prolonged exposure to flames, rather than simply burning and dripping. The charred portions of the fabric protect the wearer from the effects of fire.

Suitable hydrophilic fibers include at least one polymer selected from the group consisting of cellulose, cellulose derivative (such as cotton, viscose, linen, rayon, fire-resistant rayon, lyocell, or a combination thereof), wool, and copolymers thereof, and combinations thereof. Preferably, the hydrophilic fiber comprises cotton or fire-resistant rayon, or a combination thereof.

Suitable aramid fibers include at least one polymer selected from the group consisting of para-aramid (p-aramid) and meta-aramid (m-aramid). Examples of para-aramids include, but are not limited to, poly(p-phenylene terephthalamide), e.g., KEVLAR®(E.I. du Pont de Nemours and Company), TWARON® (Teijin Twaron BV), and TECHNORA by Teijin Company. KEVLAR is a para-aramid fiber having a very high tenacity of between 28 and 32 grams/denier and outstanding heat resistance. Examples of meta-aramids include, but are not limited to, poly(m-phenylene isophthalamide), such as NOMEX® (E.I. du Pont de Nemours and Company) and CONEX® (Teijin Twaron BV). Preferably, the structural fiber is p-aramid. Such structural fibers feature excellent thermal stability and are virtually non-flammable. These fibers have a very high resistance to heat and are resistant to melting, dripping and burning at a temperature of at least 700° F. Moreover, their LOI value is preferably in the range of between about 28 and about 30.

In certain preferred embodiments of the knitted fabric of the invention,

said first portion comprises Murata spun yarn, said Murata spun yarn comprising:
about 80%, by weight, based on the total weight of said Murata spun yarn, of modacrylic fiber;
about 15%, by weight, based on the total weight of said Murata spun yarn, of cotton fiber; and
about 5%, by weight, based on the total weight of said Murata spun yarn, of p-aramid fiber; and

said ring spun yarn comprises:
about 80%, by weight, based on the total weight of said ring spun yarn, of modacrylic fiber;
about 15%, by weight, based on the total weight of said ring spun yarn, of cotton fiber; and
about 5%, by weight, based on the total weight of said ring spun yarn, of p-aramid fiber.

In certain preferred embodiments of the knitted fabric of the invention,

said first portion comprises Murata spun yarn, Murata spun yarn comprising:
about 85%, by weight, based on the total weight of said Murata spun yarn, of modacrylic fiber; and
about 15%, by weight, based on the total weight of said Murata spun yarn, of cotton fiber; and

wherein said ring spun yarn comprises:
about 85%, by weight, based on the total weight of said ring spun yarn, of modacrylic fiber; and
about 15%, by weight, based on the total weight of said ring spun yarn, of cotton fiber.

In certain embodiments, the fabric further comprises a dye. In certain embodiments, the air jet spun yarn comprises at least one optional dye; and the ring spun yarn comprises at least one optional dye. In yet other embodiments, the fabric and/or garment of the invention is painted. In preferred embodiments, the dye is a fluorescent dye.

The knitted fabric in accordance with some embodiment may be used in garments and apparel requiring high-visibility for safety. The knitted fabric of certain embodiments of the present invention can also include dyes that meet or exceed the performance requirements provided in the American National Standard for High-Visibility Safety Apparel and Headwear standard ANSI/ISEA 107-2004, which is incorporated by reference herein. The dye is applied to the yarns used to form the knitted fabric or to the fabric itself to define a chromaticity, luminance, colorfastness, and/or minimum coefficient of retroreflection (for Level 1 retroreflective or combined-performance material) that comply with the respective requirements of ANSI/ISEA 107-2004.

In certain embodiments, the knitted fabric has a basis weight of at least about 7.5 ounces/square yard (OPSY). In preferred embodiments, the knitted fabric has a basis weight of at least about 8.0 ounces/square yard (OPSY). In preferred embodiments, the knitted fabric has a basis weight of at least about 8.7 ounces/square yard (OPSY).

In certain preferred embodiments, the knitted fabric has a basis weight of less than about 12 ounces/square yard (OPSY). In more preferred embodiments, the knitted fabric has a basis weight of less than about 10 ounces/square yard (OPSY).

In certain aspects, the invention is directed to a garment or linen comprising a fabric described herein;

wherein said first portion forms the outside of said garment or linen; and

wherein said second portion forms the inside of said garment or linen.

In certain embodiments, the yarns used in the fabric of the invention have a yarn count of between about 12/2 c.c. and about 32/2 c.c. (two ply yarn). In other embodiments, the yarn used is single ply.

In certain embodiments of the invention, the air jet spun yarn, ring spun yarn, and/or SIRO yarn is optionally blended with from between about 3% and 5%, by weight, based on the total weight of the particular yarn, of conductive fibers in order to impart anti-static properties to the fabric. Such fibers are available from several sources. The conductive yarn fibers are preferably intermixed with the high performance yarns; in other words, the conductive yarns are knitted together with the high performance yarns.

One example of such conductive fiber is NEGASTAT® produced by E.I. du Pont de Nemours and Company. This is a carbon fiber comprising a carbon core of conductive carbon surrounded by non-conductive polymer cover, either nylon or thermoplastic fiber. Another example is RESISTAT® made Shakespeare Conductive Fibers LLC. This is a fiber where the fine carbon particles are embossed on the surface of a nylon filament. The yarns of both such fibers are available in a denier of at least 40.

Instead of conductive fabric fibers, one may use a very fine wire made of steel, copper, or other metal. By way of example, a steel wire suitable for use in the inventive fabric is available under the names Bekinox and Bekitex from Bekaert S.A. in a diameter as small as 0.035 millimeter.

A very effective conductive fiber that is suitable for the inventive fabric is the product X-static made by Noble Fiber Technologies. This is a nylon fiber coated with a metal layer, namely a silver layer; it provides excellent static draining performance as well as germicidical properties. The latter prevents development of objectionable odors. The X-static fibers are blended with modacrylics in the process of yarn spinning. A content of between about 3% and 5%, by weight, based on the total weight of the yarn, of the X-static in the inventive fabric is sufficient to substantially control the static problem. The X-static fibers in the fabric must meet the standards of static control set forth by Noble Fiber Technologies, Inc.

The conductive fibers may be introduced in the inventive fabric from warps or individual packages placed on a creel, the latter being the case with circular knitting system. For warp knits, one or two guide bars threaded with the conductive yarns may be employed. These bars could move in a zigzag or diamond configuration in order to provide optimum anti-static coverage.

The knitted fabric may contain other components and treatments. For example, the fabric may contain anti-microbial and/or anti-odor components, such as, for example, triclosan, silver, and the like.

The invention relates generally to devices, systems, and methods that are useful for tracking at least one garment for the purpose of monitoring and optionally alerting the user of the garment and/or others regarding the safety, health, environmental, and security aspects of the garment, user, and/or the environment in which the user is present. The following description of the preferred embodiment(s) is merely exemplary in nature and is in no way intended to limit the invention, its application, or uses.

There exists a need to use machine-readable tracking technology, referred to herein as “traceable marker memory device,” to uniquely identify garments and to associate the garment with a particular user in a particular environment to monitor and ensure safety, health, environmental, and/or safety compliance. The garments may be tracked piece-by-piece, in batches, or in other configurations.

In one embodiment, the garment, comprising:

fabric; and

at least one traceable marker memory device in contact with said fabric;

wherein said traceable marker comprises information selected from the group consisting of identity of a user, identity of said garment, time in/out of a user, elapsed time from a triggering event, global positioning of a user, physiological characteristic of a user, environmental condition of a user, exposure level of a user, service life of said garment, compliance level of said user, and combinations thereof. In certain embodiments, the garment is preferably washable, either in a home or industrial laundry.

In certain embodiments, the traceable marker memory device is passive. In other embodiments, the traceable marker memory device is active. The traceable marker memory device may be attached to a surface of the garment or embedded within the fabric.

In certain embodiments, the traceable marker memory device is an RFID tag, optical code, magnetic code, smart label, or a global positioning system (gps) tag, or a combination thereof.

In certain embodiments, the system, comprises:

at least one garment described herein; and

a detector for said traceable marker memory device.

In certain embodiments, the system, comprises:

at least one garment described herein;

a detector for the traceable marker memory device; and

a detector for the sensor.

In certain embodiments, the detector or reader for said traceable marker is portable. In certain embodiments, the detector or reader for the sensor is portable. For example, the detector or reader of the traceable marker and/or sensor may be handheld, such as, for example, by a utility worker or supervisor, or it can be mounted, such as, for example, in a vehicle, such a utility vehicle or fire truck.

In certain embodiments, the reader for said traceable marker is capable of reading said traceable marker and decoding said marker.

In certain embodiments, the reader for said traceable marker is an RFID reader, CCD camera with decoding software, smart label reader, a GPS control and monitoring system, or combinations thereof.

In certain embodiments, the system, further comprises an alert (sound such as a beep or alarm, text message, voice message, visual sign such as a flashing light, tactile signal such as a vibration) said when garment falls outside of at least one criteria for use of said garment.

### RFID Tags and System for Reading

Suitable RFID tags include those described in U.S. Pat. No. 7,759,471 and U.S. Pat. No. 7,091,861, which are incorporated herein by reference in their entirety. In certain embodiments, certain radio frequency identification (RFID) tags are attached to the garment and a reader (also called a detector herein) that obtains information associated with the particular garment and its user through radio frequency. An RFID tag typically includes a memory for storing data, an antenna, an RF transmitter and receiver or an RF transceiver to transmit data, and logic for controlling the various components of the memory device. RFID tags can either be passive or active devices. Active devices are self-powered, by a battery for example. Passive devices do not contain a discrete power source but derive their energy from an RF signal used to interrogate the RFID tag. A reader is used to obtain information associated with the particular garment through radio frequency. The reader is in electrical communication with a computer system having a database of information about the compliance standards with respect to safety, health, environment, and/or security with respect to a particular garment and a particular user. After detecting the radio frequency signal from the RFID tag, the reader causes the computer system to analyze and compare the data with respect to the particular garment and particular user.

A reader is a radio frequency emitter/receiver or interrogator. In accordance with general RFID tag methodology, the reader interrogates RFID tags that are within its range by emitting radio frequency waves at a certain frequency. Each tag may respond to a unique set of interrogation frequencies. An RFID tag typically responds to an interrogation by emitting or responding with coded or identification information as a radio frequency signal or signature and this signal or signature (whether actively or passively) is detected by the reader. The reader is in electrical communication with a computer system having a database of information about the inventory. After detecting the radio frequency signal from the RFID tag, the reader causes the computer system to change the data in the database to account for the presence of a particular inventory item.

RFID tags are generally classified into two broad groups, passive and active. Passive tags do not include a power supply of their own, while active RFID tags include a power supply such as a battery. Active RFID tags are typically able to be read from greater distances when compared to passive RFID tags. In addition, active tags can typically store and transmit more information than can passive RFID tags. However, active RFID tags are typically larger and more expensive then passive RFID tags. In addition, active RFID tags have a limited life span due to their need for an internal power supply.

RFID tags, whether passive or active, include an antenna and a transponder. The transponder may include memory (e.g., RAM, ROM, and/or non-volatile memory (EEPROM)) as well as analog or digital circuitry. The antenna provides for the communication link between a reader and the RFID tag.

While active tags derive their power from a battery or other energy storage device, passive tags receive power from the field generated by the reader. Passive tags generally rely on inductive coupling to transfer both power and data between the tag and the reader. For inductive coupling to function, the reader must produce a strong high-frequency field. The antennae of the reader and the tag, when in close proximity, establish a loosely connected “space transformer” which allows for the transfer of power to the RFID tag. The power operates the transponder circuitry, which transmits data to the reader if the RFID tag is properly queried.

Many frequency ranges can be used to operate passive RFID tags. However, three ranges have emerged in the industry, with each range having advantages and drawbacks. The low frequency range (approximately 100-500 kHz) allows for short to medium read ranges and is inexpensive to operate. However, the relatively slow reading speed inhibits the use of low frequency systems where many tags must be read quickly. The intermediate range (approximately 10-15 MHz) allows for short to medium read ranges, is potentially inexpensive, and provides for medium reading speed. The high range (approximately 850-950 MHz and 2.4-5.8 GHz) provides for long read range and a high reading speed (e.g., 2 megabits per second or faster). However, the high frequency RFID tags are expensive to manufacture and may require a line-of-sight to be read. As such, the medium frequency range or the low frequency range is preferable over the high frequency range.

In one construction, an RFID tag placed within the alternating magnetic field created by the reader draws energy from the magnetic field. This additional power consumption can be measured remotely as a voltage perturbation at the internal impedance of the reader antenna. The periodic switching on and off of a load resistance at the tag therefore causes voltage changes at the reader's antenna and thus has the effect of an amplitude modulation of the antenna voltage by the remote tag. If the switching on and off of the load resistor is controlled by the tag's stored data stream, and then this data is transferred from the tag to the reader. This type of data transfer is called load modulation. The process of load modulation creates amplitude modulated sidebands symmetrically placed around the 13.56 MHz interrogation carrier frequency.

Because the coupling between reader antenna and tag is relatively weak and the voltage change created by the tag leads to relatively poor signal-to-noise ratios, reply code modulation with a sub carrier is utilized in most RFID chips. In this improved signaling method, the tag's data reply information is contained in a pair of backscattered sidebands which are subsequently demodulated in the RF and baseband signal processing sections of the reader to recover the tag's data stream. In ISO 15693 chips, for example, the sub carrier frequency is equal to 423.75 kHz (Fc/32) with either FSK or OOK modulation and Manchester data coding. The achievable label data transfer rate is up to a relatively fast 26.48 Kbps.

Passive RFID tags are preferred for many reasons including their ability to be manufactured in large quantities and at sizes of less than ⅓ of a millimeter. In addition, passive RFID tags can store 128 bits, 256 bits or more data as required. Furthermore, passive RFID tags 33 can be read from several feet away without a clear line of sight.

Passive RFID tags can be made small enough to be essentially hidden anywhere on or in the garment. The RFID tag may be attached to the second surface of the garment to assure that it remains hidden from view or does not interfere with the information printed on a label, for example.

In certain embodiments, the RFID tag is selected from a group consisting of an international organization for standardization (ISO) 18000 tag and an Audio Center electronic product code (EPC) tag.

### Optical Codes and System for Reading

Suitable optical codes include bar codes, or any numerical, textual, or graphical codes. Suitable optical codes also include two dimensional encrypted, steganographic symbology from InfoGlyph.

One such method of detecting the optical codes utilizes an optical scanner, in communication with a computer and database, which reads an encoded optical pattern of a bar code, for example, attached to the garment. Individual garments may be identified by the encoded optical pattern of the attached bar code. The optical scanner usually converts the encoded optical pattern of a bar code into an electrical signal that represents an identification code associated in the database with a particular garment and particular user. The computer typically contains a memory with database information about each surgical instrument and correlates that information to the identification code. The computer may then be programmed to produce information to a user in a variety of formats useful in an inventory procedure.

In another construction, the garment includes a traceable marker in the form of a bar code (e.g., micro bar code) printed on the surface of the garment. The bar code can be printed during the manufacture of the garment or during a separate printing step. In addition, the bar code can be hidden within a garment label or elsewhere. Like the RFID tag, the bar code is able to store data related to the garment and convey that data whenever the garment passes near a reading device. Unlike RFID, the bar code requires a clear line of sight between the reader and the bar code in order for the data to be read. The line of sight can be provided using mirrors or lenses, if desired. However, an opaque object between the bar code and the reader can inhibit or prevent reading of the bar code.

### Magnetic Code Tags

Suitable magnetic code tags are described in U.S. Pat. No. 4,940,966, U.S. Pat. No. 5,420,569, and U.S. Pat. No. 5,821,859, which are incorporated herein by reference. Some of the magnetic code tags that serve both as an identifier of the article to which it is attached and as an antitheft device. The former attribute is especially important should stolen property be recovered. Identification comes about through the use of an array of individual magnetic elements that are closely spaced, preferably along an amorphous wire. The magnetic elements can take the form of magnetic ink, high coercivity wire, thin foil, or amorphous wire. The array may be personalized (coded) by leaving out elements of the array or driving selected elements to saturation while others remain demagnetized. The elements can also be in the form of a single or double array to constitute 1's and 0's to form a code. Reading of the elements is accomplished with a special reading head consisting of one or more small magnetic circuits coupled to one or more pickup loops. A longer length of soft magnetic wire or thin strip is used to trigger an anti-theft alarm when activated by an external field from a magnetic gate. In certain embodiments, the anti-theft element is an integral part of the code array. The integrated identification and alarm devices are capable of being concealed in the article to be protected and identified, but need not be concealed. A reader interprets the encoded information for purposes of identifying the manufacturer, date of manufacture, and the like. Special reading heads may be used to interpret the magnetic information that is transformed by means of a computer to a data file. The magnetic tags may be concealed within a garment. In certain embodiments, tampering with the magnetic code tag destroys the item to which it is attached. Various magnetic effects may be used to make the magnetic elements function as a code, including the use of magnetic domain reversal of soft magnetic materials to produce a pulse corresponding to an information bit as well as the Matteucci effect.

### Smart Label

A smart label, also called smart tag, is an extremely flatly configured transponder under a conventional print-coded label, which includes chip, antenna and bonding wires as a so-called inlay. The labels, which may be made of paper, fabric, plastic and the like, are prepared as a roll with the inlays laminated between the rolled carrier and the label media for use in specially designed printer units. The inlay is inserted in an automated processing step to ensure identical positioning for each label and careful processing to prevent any damage to the bonding. The printing is processed in two steps, including conventional ink jet printing, except the space with the bonded chip, with clearly intelligible text and either barcode or 2D barcode for later semi-automatic reading with handheld readers or fix-mount scanners. The first step is writing coherently concatenated information to the RFID-chip. The second step is reading the written information on the RFID-chip subsequently in the printer for control purpose (read after write).

### GPS Tags

Suitable global positioning tags that may be used in certain embodiments of the garments of the invention include those described in U.S. Pat. No. 7,518,502 and U.S. Pat. No. 6,131,067, which are incorporated herein by reference in their entirety. For example, in U.S. Pat. No. 6,131,067, a client-server based system is described in which the location of a tracking device is determined using GPS information. This location is then reported to a user via the Internet.

### Sensors

In certain embodiments, the garment further comprises at least one sensor. In certain embodiments, the sensor measures real-time at least one parameter selected from said global positioning of a user, said physiological characteristic of a user (such as, for example, body temperature, blood pressure, pulse, respiration, blood sugar level, skin resistance, and combinations thereof), said environmental condition of a user (such as temperature, humidity, pressure, sound level, weather, chemical hazard exposure, radiation exposure, biological hazard exposure, electrical hazard, and combinations thereof), said exposure level of a user, and combinations thereof.

Body monitoring devices have been developed that are said to have the ability to measure a number of physiologic parameters (bio-readings) that allow health researchers and professionals, as well as individuals, to continuously and more accurately track physical activity and energy expenditure. Such prior art systems are said to be able to accurately monitor heat flow, galvanic skin response, skin temperature, near body ambient temperature, heart beat and transfer such data to a remote computer for analysis. Algorithms have also been developed said to be capable of integrating multiple physiological variables from developed said to be capable of integrating multiple physiological variables from the wearable sensor to predict calories burned, length in time of exercise, number of steps taken, resting energy expenditure, active energy expenditure, sleep onset, wake time and sleep duration.

Examples of suitable sensors are described in the following documents, which are incorporated herein by reference:
(1) U.S. Pat. No. 7,463,142
(2) M. Klemm, I. Locher, G. Tröster, “A Novel Circularly Polarized Textile Antenna for Wearable Applications,” Proc. of 7th European Microwave Week, pp. 137-140,

(2004).
(3) R. Paradiso, G. Loriga, N. Taccini, “A Wearable Health Care System Based on Knitted Integrated Sensors”, IEEE Transactions on Information Technology in Biomedicine, 9, no 3 pp. 337-344, (2005).
(4) S. Park, S. Jayaraman, “Enhancing the quality of life through wearable technology,” IEEE Eng. Med. Biol. Mag., 22, no 3, pp. 41-48, (2003).
(5) P. Salonen, H. Hurme, “A novel fabric WLAN antenna for wearable applications,” IEEE Antennas and Propagation Society International Symposium, 2, pp. 700-703, (2003).
(6) G. Vermeeren, H. Rogier, F. Olyslager, D. De Zutter. “Simple low-cost planar antenna for indoor communication under the Bluetooth protocol,” Electronics Letters, 37, pp. 1153-1154, (2001); and
(7) www.proetex.org.

In certain embodiments, the fabric used in the garment is fire-resistant, anti-static, and/or anti-ballistic.

In certain embodiments, the garment is a shirt, pants, underwear, outerwear, footwear, headwear, swimwear, belt, glove, headband, wristband, or a combination thereof.

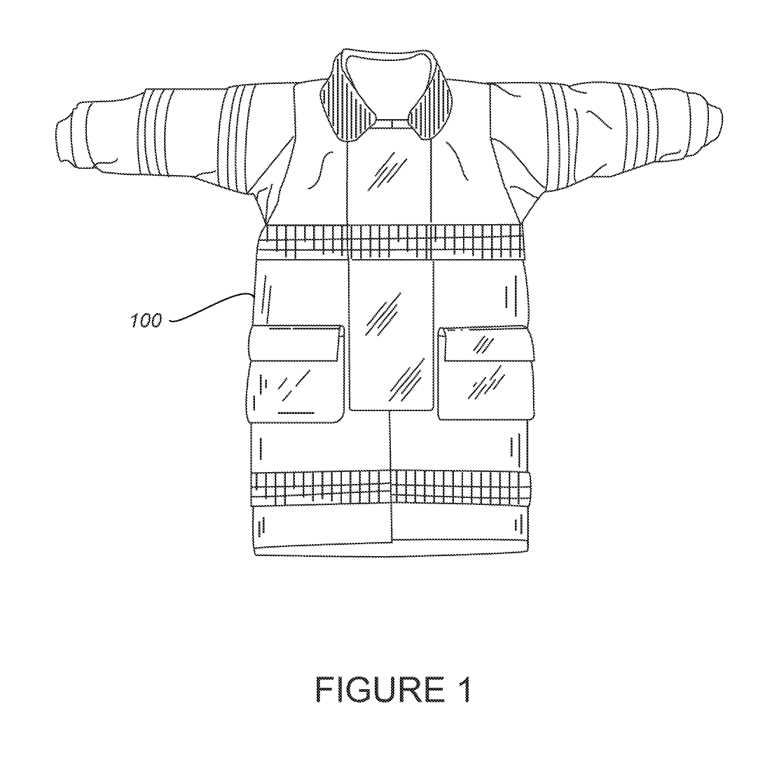

Various aspects of the invention may relate to a system and method for uniquely identifying garments and associating the garment with a particular user in a particular environment. FIG. 1 illustrates an embodiment of a garment 100, where the representative garment could be either an utility worker's coat or a fireman's turnout coat. Other embodiments of garment 100 may include a shirt, pants, underwear, outerwear (such as, for example, a coat, including a turnout coat, a lab coat, overalls, a smock, a uniform, or a combination thereof), footwear, headwear, swimwear, belt, glove, headband, wristband, or a combination thereof. Garment 100 may be required or optional attire for persons engaged in certain activities within an institution or facility. The institution or facility may include a chemical plant or research facility, a biological manufacturing plant or research facility, nuclear reactor, and/or waste treatment plant with respect to engineers, technicians, plant workers, and utility workers; an oil exploration site or an oil refining site with respect to engineers and oil facility workers; residential, academic, governmental, commercial, industrial, and military facilities with respect to fire fighters, police, utility workers, and military personnel, or combinations thereof.

Garment 100 may be provided to persons for use on a temporary basis, such as for a task or tasks, for a shift, for a day, for any other length of time, or other temporary bases depending upon the safety, health, environment, and/or security needs of the user. The institution or facility may then require the garment 100 be returned to the institution. Alternatively, garment 100 may be provided to persons for use on a permanent basis until the service life of the garment is spent.

Once worn, the institution may process garment 100 to make it suitable for re-use, before providing garment 100 to the same or different user. Processing may include laundering, mending, sterilizing, or other processing.

According to some embodiments of the invention, the location of garment 100 may be tracked during the garment's lifetime. Garment 100 may be tracked while being worn, while being processed, while being stored, and/or at other times. Tracking may include the ability to associate a uniquely identified garment 100 with particular users, particular departments, and/or other entity. The association may be established at a time the garment 100 is issued to the particular users, particular departments, and/or other entity and may be updated periodically to account for movement of the garment 100.

According to one embodiment of the invention, the identification tracking markers are placed on or embedded within the fabric(s) used to make the garment 100 to facilitate an accounting of each garment 100 individually. Accordingly, although a plurality of garments 100 may include identical characteristics and may appear otherwise indistinguishable, the garments 100 may be separately identified using the identification tracking markers. In another embodiment of the invention, individual garments 100 that are uniquely identifiable using-the identification tracking markers may be associated with particular users, particular departments, and/or other entities. Accordingly, the process of locating the garments 100 may include identifying and/or locating the particular users, particular departments, and/or other entities that are associated with the garment 100. In one embodiment of the invention, searches for desired garments 100 may be conducted using hierarchical processing including tracking garments 100 to a particular institution, refining the search to a processing area within the institution and further refining the search to a more particular location within the processing area. Other types of hierarchical processing may be employed. In another embodiment of the invention, searches for desired garments 100 may be conducted using non-hierarchical processing. While particular embodiments are provided herein, it will be understood by one of ordinary skill in the art that different searching techniques may be employed to locate desired garments 100.

According to one embodiment of the invention, garments 100 may be tracked before, during, and/or after use (i.e., while being worn by an individual or wearer); before, during, and/or after processing (i.e., while being not worn by an individual or wearer but during cleaning, repair, storage, and/or other processing); and/or at another time. In an exemplary embodiment, tracking may be implemented using application-specific software and readers, among other techniques.

Tracking may be used to establish safety, health, environmental, safety, and/or other tracking purposes, for the garments 100 at various points in the garment's lifetime. Tracking may reduce and/or prevent incidents of unauthorized use of garments, and/or other incidents associated with garment 100. To ensure safety, health, environmental, and/or security compliance with respect to a particular garment, tracking may be used to establish identity of a user, identity of the garment, time in/out of a user, elapsed time from a triggering event, global positioning of a user, physiological characteristic of a user, environmental condition of a user, exposure level of a user, service life of the garment, and combinations thereof.

According to various embodiments of the invention, garment 100 may be provided with a traceable marker memory device. As used herein, “traceable marker memory device” is any device having machine-readable data encoded (embedded microprocessor and/or memory) on physical media, including but not limited to radio frequency identification (RFID) tags, optical codes (bar codes, or any numerical, textual, or graphical codes), global positioning systems (gps) chips, smart label, magnetic tag, or other intelligent information coding. Suitable traceable marker memory devices also include two dimensional encrypted, steganographic symbology from InfoGlyph.

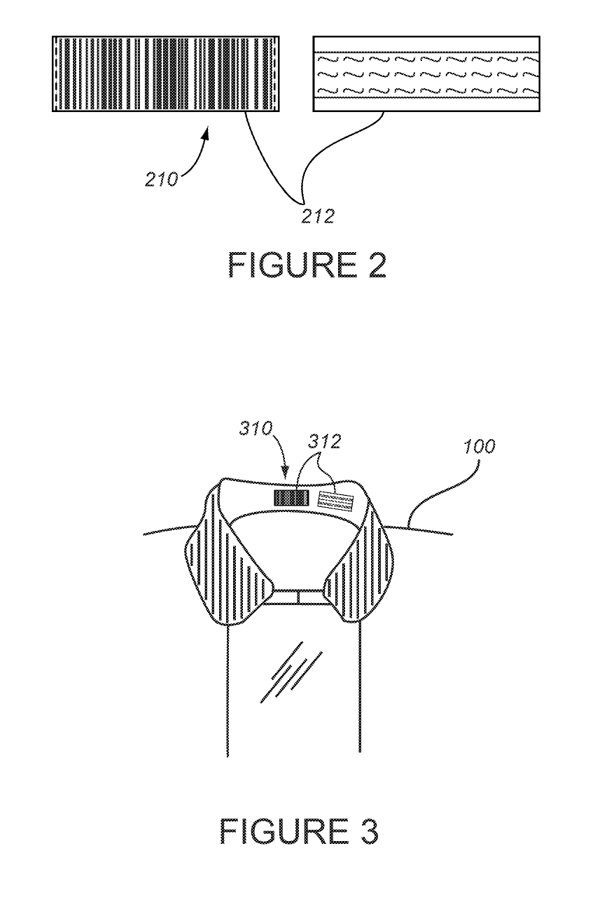

FIG. 2 illustrates an exemplary embodiment of traceable marker memory device 210. Identification tracking marker 210 may include one or more identifiers 212. In one exemplary embodiment, identifier 212 may include an optical identifier, such as a bar code or other optical code configuration. In another embodiment of the invention, the optical identifier may include a two-dimensional bar code. In yet another exemplary embodiment, identifier 212 may include a magnetic identifier, such as a binary magnetic medium or other magnetic medium. Identifier 212 may include tracking data regarding garment 100, such as, identity of a user, identity of the garment, time in/out of a user, elapsed time from a triggering event, global positioning of a user, physiological characteristic of a user, environmental condition of a user, exposure level of a user, service life of the garment, institution data, and/or other tracking data.

One exemplary embodiment may include optical identifiers having bar codes, specifically, high-capacity 2-dimensional (2D) bar codes that are placed on a label (such as a care label) that is attached to garment 100. The optical identifiers may be designed to withstand the various environments that are imposed upon a garment during its lifetime. In one exemplary embodiment of the invention, the bar codes may be printed using specialized thermal transfer or other inks onto a specially formulated substrate (label material), the combination of which is able to withstand the harsh environmental conditions, including temperature, humidity, the presence of high concentrations of bleach and enzymes, and other environmental conditions, while remaining intact and functional. Intact and functional includes being readily scannable by the system's bar code scanners.

According to one embodiment of the invention, the bar codes may be proprietary in design or off the shelf; may encode unique item identification information literally or in an encrypted manner; and/or may be printed with inks visible or invisible to the naked eye. The labels on which the bar codes are printed may contain visible or invisible, or otherwise hard-to-detect physical features, including taggants, watermarks, or other features. In another embodiment, the bar codes may be attached using sew on techniques, heat seal techniques or other attaching techniques.

In yet another embodiment of the invention, labels may be manufactured with unique bar codes that are integral with the label, such as woven, interleaved, or other integral configuration, and may be placed at the time of manufacture of the label. According to one exemplary embodiment, the optical identifiers may uniquely identify each garment 100. In another embodiment of the invention, the optical identifiers may employ proprietary configurations. In an exemplary embodiment of the invention, the bar code may be scanned using known scanner technology and may be processed via a software application.

Another exemplary embodiment of the invention may include using magnetic identifiers that employ magnetic identification. In one embodiment of the invention, the magnetic identifiers may employ proprietary signals.

In some embodiments, tracking data included in identifier 212 may be encrypted. Encryption enables proprietary access to tracking data. Access may be granted when a known identifier is provided. Further, an encryption key may be used to encrypt the tracking data, wherein the encryption key may be specific to an institution or facility. Therefore, an institution having an encrypted identifier associated with garment 100 may be afforded the security that tracking data included in identifier 212 will only be accessible by that institution or facility because other parties will not be able to de-encrypt the tracking data.

FIG. 3 illustrates an exemplary embodiment of traceable marker memory device 210 provided on garment 100. It will be appreciated that the embodiment of FIG. 3 has been provided for illustrative purposes only and that traceable marker memory device 210 may be provided at any location on garment 100, such as inside a collar, on a cuff, on a pocket, or other locations. Alternatively, the traceable marker memory device 210 may be any machine-readable data encoded (embedded microprocessor and/or memory) on physical media, including but not limited to radio frequency identification (RFID) tags, optical codes (bar codes, or any numerical, textual, or graphical codes), global positioning systems (gps) chips, smart label, magnetic tag, or other intelligent information coding. For systems requiring optical reading, it is preferable that the traceable marker memory device is within line-of-sight of the reader or detector. Traceable marker memory device 210 may be provided to garment 100 at manufacture or may be provided sometime thereafter, independent of the manufacturing process.

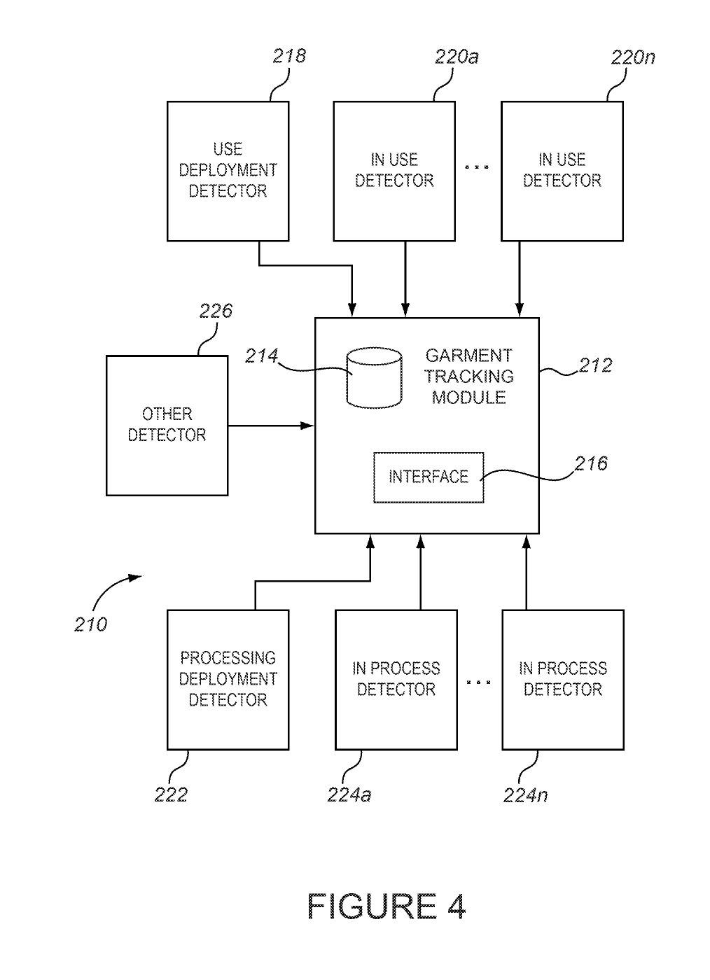

FIG. 4 illustrates an embodiment of a garment tracking system 210 for tracking garment 100. Garment tracking system 210 may include a garment tracking module 212. Garment tracking module 212 may include a memory or tracking data storage 214. Tracking data storage 214 may store tracking data that may include an inventory of garments and corresponding identification tracking markers, garment location data, institution data, user data, or other data. It will be appreciated that while tracking data storage 214 is illustrated as a single entity, tracking data storage 214 may include one or more data storage mediums, or a combination of data storage mediums, such as one or more electronic databases, one or more paper records, or other data storage mediums.

In some embodiments of the invention, garment tracking module 212 may include a garment tracking interface 216. Garment tracking interface 216 may convey tracking data. The tracking data may be conveyed through a graphical user interface, a printout, an audible message, or other data conveying device. The tracking data conveyed by garment tracking interface 216 may be stored in tracking data storage 214. Garment tracking interface 216 may further enable manipulation of tracking data, such as the tracking data stored in tracking data storage 214, or other tracking data. It will be appreciated that although garment tracking interface 216 is illustrated as a single interface, more than one interface may be provided. This may enable more than one user to concurrently access the tracking data.

Although garment tracking module 212 is shown as a single element, it will be appreciated that this embodiment is for illustrative purposes only. Alternatively, garment tracking module 212 may include one or more modules and/or sub-modules operating from a single location, or operating remotely from a plurality of locations.

According to various embodiments, garment tracking system 210 may include a use deployment detector 218. Use deployment detector 218 may be used to detect tracking data when garment 100 is provided to persons for use on a temporary or other basis. The tracking data detected by use deployment detector 218 may include deployment date data, deployment time data, user data, garment identification data associated with garment 100, return date data, return time data, institute identification data, or other tracking data. Use deployment detector 218 may be operatively connected to garment tracking module 212, and may provide tracking data to tracking data storage 214. In an exemplary embodiment of the invention, use deployment detector 218 may communicate with the garment tracking module 212 over a wireless or wired medium.

In some embodiments, garment tracking system 210 may include one or more in-use detectors 220 (220a, 220n). In-use detector 220 may detect tracking data while garment 100 is being used. The tracking data detected by in-use detector 220 may include garment location data, garment identification data associated with garment 100, date data, time data, institution data, or other tracking data. In-use detector 220 may be operatively linked to garment tracking module 212 and may provide tracking data to tracking data storage 214. In an exemplary embodiment, in-use detector 220 may communicate with the garment tracking module 212 over a wireless or wired medium.

According to various embodiments of the invention, garment tracking system 210 may include a processing deployment detector 222. Processing deployment detector 222 may be used to detect tracking data when processing of garment 100 is at a predetermined stage, such as at the beginning of use, end of use, or other stages. The tracking data detected by processing deployment detector 222 may include processing data, deployment date data, deployment time data, garment identification data associated with garment 100, return date data, return time data, institute identification data, or other tracking data.

Processing deployment detector 222 may be operatively connected to garment tracking module 212 and may provide tracking data to tracking data storage 214. In an exemplary embodiment, processing deployment detector 222 may communicate with the garment tracking module 212 over a wireless or wired medium.

According to some embodiments, garment tracking system 210 may include one or more in-process detectors 224. In-process detector 224 may detect tracking data while garment 100 is being processed. The tracking data detected by in-process detector 224 may include process data, process stage data, garment location data, garment identification data associated with garment 100, date data, time data, institution data, or other tracking data. In-process detector 224 may be operatively linked to garment tracking module 212 and may provide tracking data to tracking data storage 214. In an exemplary embodiment, in-process detector 224 may communicate with the garment tracking module 212 over a wireless or wired medium.

According to various embodiments, garment tracking system 210 may include one or more other detectors 226. Other detector 226 may be used to detect tracking data related to garment 100 when garment 100 is not be used or processed. The tracking data detected by other detector 226 may include, garment location data, garment identification data for garment 100, date data, time data, institution data, or other tracking data. In an exemplary embodiment, other detectors 226 may communicate with the garment tracking module 212 over a wireless or wired medium.

In some embodiments of the invention, garment tracking system 210 may be used to track garment 100 during use and/or while being processed. Tracking data associated with garment 100 may be generated, stored, and/or conveyed in order to monitor parameters associated with garment 100. In an exemplary embodiment of the invention, garment tracking system 210 may detect the person using garment 100, the location of garment 100, the processing status of garment 100, the real time processing stage of garment 100, or other information related to garment 100. Garment tracking system 210 may also provide a history of garment 100 to determine when the garment was last detected by garment tracking system 210 and provide other historical information. The history may provide benefits to the institution, such as, aid in finding garment 100 if it becomes lost, aid in holding a party or parties accountable for garment 100 if it becomes lost, or some other benefit.

In certain embodiments, the invention is directed to methods of confirming adherence to a safety, health, or environmental standard of a user of a garment, comprising:

providing at least one garment, comprising:
fabric; and
at least one traceable marker memory device in contact with said fabric;
wherein said traceable marker memory device comprises information selected from the group consisting of identity of a user, identity of said garment, time in/out of a user, elapsed time from a triggering event, global positioning of a user, physiological characteristic of a user, environmental condition of a user, exposure level of a user, service life of said garment, compliance level of said user, and combinations thereof;

reading said traceable marker to provide usage information; and

determining whether usage information falls outside of at least one criterion for use of said garment.

In certain embodiments, the method further comprises:

alerting said user that said garment falls outside of at least one criteria for use of said garment.

In certain embodiments, the method further comprises:

alerting at least one supervisor of said user that said garment falls outside of at least one criteria for use of said garment.

In certain embodiments, the method further comprises:

preventing ingress into or egress from a facility or institution.

In certain embodiments, the facility or institution is a chemical plant, a biological manufacturing plant, a waste treatment plant, an oil exploration site, an oil refining site, fire house, firefighter vehicle, or a combination thereof.

In certain embodiments, the user is a worker at a chemical, industrial, or oil refining facility, utility worker, firefighter, police officer, military personnel, or a combination thereof.

The traceable marker memory device 310 may include one or more identifiers 312 such that identifiers 312 may include tracking data associated with garment 100, wherein identifiers 312 may be detected by one or more of use deployment detectors-218, in-use detectors 220, processing deployment detectors 222, in-process detectors 224, and/or other detectors 226. This may enable detected tracking data associated with garment 100 to be provided to garment tracking module 212.

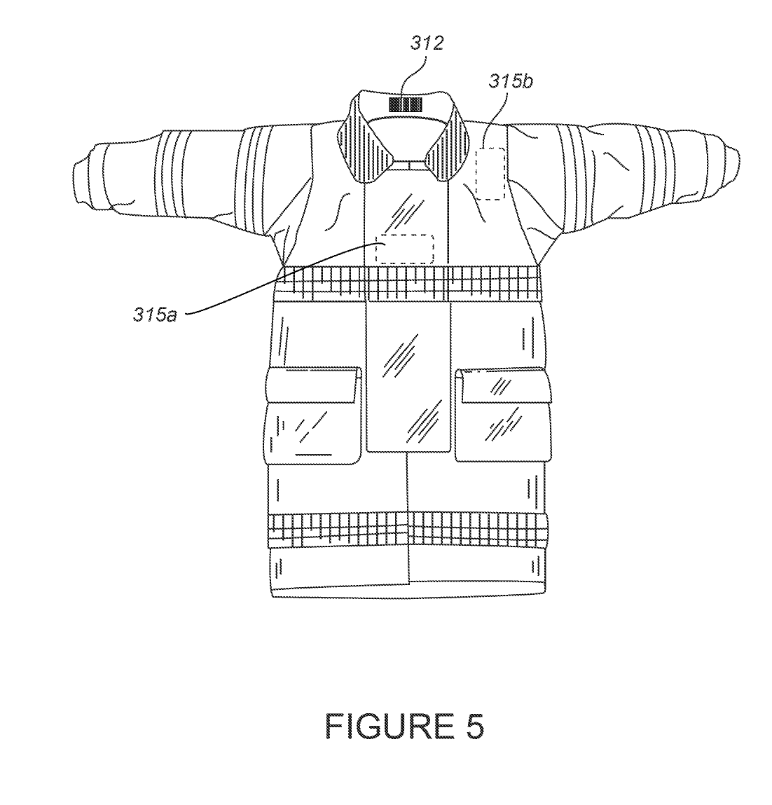

As shown in FIG. 5, the garment 100 may optionally include one or more sensors 315a, 315b, which are exposed on the inner portions of the garment adjacent to the wearer's skin (not shown). Sensors 315a and 315b measure, preferably real-time, at least one parameter selected from said global positioning of a user, said physiological characteristic of a user (such as, for example, body temperature, blood pressure, pulse, respiration, blood sugar level, skin resistance, and combinations thereof), said environmental condition of a user (temperature, humidity, pressure, sound level, weather, chemical hazard exposure, radiation exposure, biological hazard exposure, electrical hazard, and combinations thereof), said exposure level of a user, and combinations thereof.

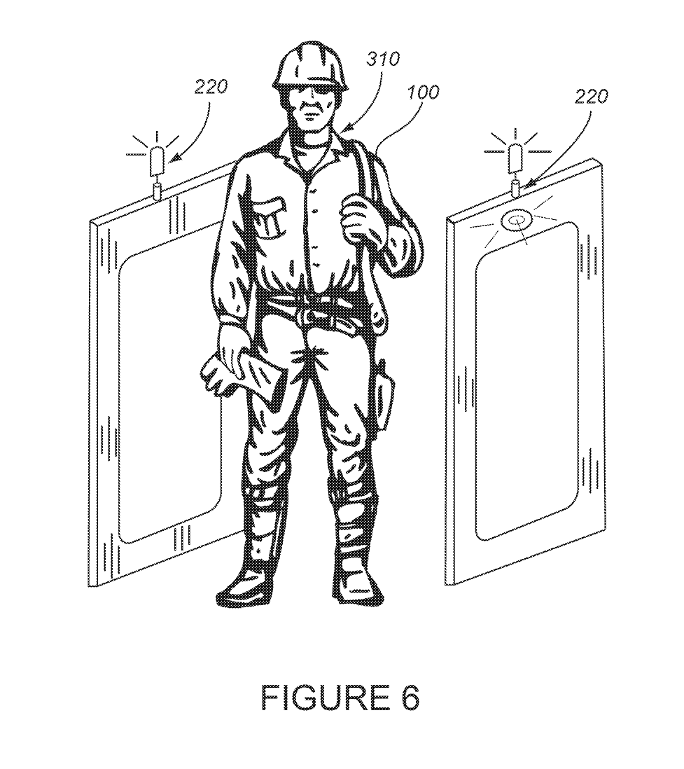

FIG. 6 illustrates an exemplary embodiment of the system having a detector for the one traceable marker memory device 220. Detector 220 may be a magnetic detector and identifier 312 may be a magnetic identifier. Detector 220 may detect tracking data contained in identifier 312 of identification tracking marker 310 regarding garment 100. Tracking data detected by in-use detector 220 may be associated with additional tracking data, such as, a date of detection, a time of detection, a detection location, or other tracking data. The combined tracking data may then be provided to garment tracking module 212 in real-time and/or may be stored in tracking data storage 214 for later retrieval. The tracking data detected by detector 220 and the additional tracking data may enable the location of garment 100 to be tracked throughout the usage of garment 100.

The real-time tracking of garments 100 may enable monitoring of areas within the institution where the garment 100 is taken. If the garment 100 is determined to be in an unauthorized area or other identifiable area, an alarm or other alert may be triggered in real-time to enable some action to be taken, either by the user of the garment, the supervisor of the user, and/or by a third party. Alternatively, tracking data associated with garment 100 that is determined to be in an unauthorized area or other identifiable area may be stored for later use. The tracking data may enable identification of entities associated with the garment 100 or other information.

The present invention is further defined in the following Examples, in which all parts and percentages are by weight, unless otherwise stated. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various usages and conditions.

### EXAMPLES

### Example 1

In this example, fabric samples were tested in accordance with ASTM International Standard Test Method F1959 to determine arc ratings. Two samples were woven fabrics and two samples were knit fabrics. The fabric specimens were laundered unless noted. Three panels of each fabric were tested. The test results are shown in the table below:

| | | Estimated Arc | |
|---|---|---|---|
| | | Rating (E_{BT}) | |
| Sample | Description | (cal/cm²) | Arc Level Rating |
| 1* | 6 ounce woven 85% | 5.7 | 1 (woven and |
| | Protex modacrylic/15% | | basis weight 6 |
| | cotton Weight after | | oz/yd²) |
| | laundering: 6.1 oz/yd² | | |
| 2* | 9 ounce double knit | 5.3 | 1 even though |
| | 73% Protex modacrylic/ | | double knit basis |
| | 14% thermoplastic fiber/ | | weight is >7.5 oz/yd² |
| | 13% rayon Weight after | | (contains >5% |
| | laundering: 9.1 oz/yd² | | thermoplastic fiber) |

*Comparative (outside scope of invention)

### Example 2

In this example, fabric samples were tested in accordance with test method ASTM F1959/F1959M-05a to determine arc ratings. The test samples were washed and dried in accordance with the ASTM standard and cut into panel test samples. The test results are shown in the table below:

| | | Estimated Arc | |
|---|---|---|---|
| | | Rating (E_{BT}) | |
| Sample | Description | (cal/cm²) | Arc Level Rating |
| 1 | Heavy Weight Mesh | 8.7 | 2 |
| | (Double knit with air | | |
| | jet and ring spun | | |
| | construction) 85% | | |
| | modacrylic/15% cotton | | |
| 2* | Heavy Weight Mesh | 6.5 | 1 Only Arc Level |
| | (Double knit with air jet | | Rating 1 even though |
| | construction only) | | double knit but |
| | 85% modacrylic/15% | | only with air jet |
| | cotton | | construction |

*Comparative (outside scope of invention)

While the preferred forms of the invention have been disclosed, it will be apparent to those skilled in the art that various changes and modifications may be made that will achieve some of the advantages of the invention without departing from the spirit and scope of the invention. For example, while tracking of garments is described herein, it will be apparent to those skilled in the art that other items may be tracked. It will be apparent to those skilled in the art that other components performing the same function may be suitably substituted. Further, the methods of the invention may be achieved in either all software implementations, using the appropriate processor instructions, or in hybrid implementations that utilize a combination of hardware logic and software logic to achieve the same results. Therefore, the scope of the invention is to be determined solely by the claims to be appended.

When ranges are used herein for physical properties, such as molecular weight, or chemical properties, such as chemical formulae, all combinations, and subcombinations of ranges specific embodiments therein are intended to be included.

The disclosures of each patent, patent application, and publication cited or described in this document are hereby incorporated herein by reference, in their entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed is:

1. A knitted fabric, comprising:
a first portion comprising a yarn selected from the group consisting of air jet spun yarn, ring spun yarn, and SIRO yarn; and
a second portion comprising a yarn selected from the group consisting of ring spun yarn and SIRO yarn;
wherein said second portion comprises no more than about 5% by weight, based on the total weight of the first portion, of a thermoplastic fiber that melts when exposed to an open flame;
wherein said first portion and said second portion are configured in a double knit with a tie yarn; and
wherein said knitted fabric has a basis weight of at least about 6.0 ounces/square yard (OPSY).

2. A knitted fabric of claim 1,
wherein said first portion comprises air jet spun yarn; and
wherein said second portion comprises ring spun yarn.

3. A knitted fabric of claim 1,
wherein said air jet spun yarn is Murata air jet spun yarn or Murata vortex yarn.

4. A knitted fabric of claim 1,
wherein said first portion comprises air jet spun yarn, said air jet spun yarn comprising:
about 80-90%, by weight, based on the total weight of said air jet spun yarn, of at least one hydrophobic fiber;
about 5-15%, by weight, based on the total weight of said air jet spun yarn, of at least one hydrophilic fiber; and
about 0-15%, by weight, based on the total weight of said air jet spun yarn, of at least one aramid fiber; and
wherein said ring spun yarn in said second portion comprises:
about 80-90%, by weight, based on the total weight of said ring spun yarn, of at least one hydrophobic fiber; and
about 10-15%, by weight, based on the total weight of said ring spun yarn of at least hydrophilic fiber; and
about 0-15%, by weight, based on the total weight of said ring jet spun yarn, of at least one aramid fiber.

5. A knitted fabric of claim 4,
wherein said hydrophobic fiber comprises at least one polymer selected from the group consisting of polypropylene, polyethyleneterephthalate, nylon, polyacrylonitrile, polybenzimidazole (PBI), fluoropolymer, and copolymers thereof, and combinations thereof.

6. A knitted fabric of claim 4,
wherein said hydrophobic fiber comprises polyacrylonitrile or copolymer thereof.

7. A knitted fabric of claim 4,
wherein said hydrophobic fiber is modacrylic fiber or modacrylic copolymer fiber.

8. A knitted fabric of claim 4,
wherein said hydrophilic fiber comprises at least one polymer selected from the group consisting of cellulose, cellulose derivative, wool, and copolymers thereof, and combinations thereof.

9. A knitted fabric of claim 8,
wherein said cellulose derivative is cotton, viscose, linen, rayon, fire-resistant rayon, lyocell, or a combination thereof.

10. A knitted fabric of claim 4,
wherein said hydrophilic fiber comprises cotton.

11. A knitted fabric of claim 4,
wherein said first portion comprises Murata spun yarn, Murata spun yarn comprising:
about 80%, by weight, based on the total weight of said Murata spun yarn, of modacrylic fiber;
about 15%, by weight, based on the total weight of said Murata spun yarn, of cotton fiber; and
about 5%, by weight, based on the total weight of said Murata spun yarn, of p-aramid fiber; and
wherein said ring spun yarn comprises:
about 80%, by weight, based on the total weight of said ring spun yarn, of modacrylic fiber;
about 15%, by weight, based on the total weight of said ring spun yarn, of cotton fiber; and
about 5%, by weight, based on the total weight of said ring spun yarn, of p-aramid fiber.

12. A knitted fabric of claim 4,
wherein said first portion comprises Murata spun yarn, said Murata spun yarn comprising:
about 85%, by weight, based on the total weight of said Murata spun yarn, of modacrylic fiber; and
about 15%, by weight, based on the total weight of said Murata spun yarn, of cotton fiber; and
wherein said ring spun yarn comprises:
about 85%, by weight, based on the total weight of said ring spun yarn, of modacrylic fiber; and
about 15%, by weight, based on the total weight of said ring spun yarn, of cotton fiber.

13. A knitted fabric of claim 4, further comprising a dye.

14. A knitted fabric of claim 13,
wherein said dye is a fluorescent dye.

15. A knitted fabric of claim 4,
wherein said air jet spun yarn comprises at least one optional dye; and
wherein said ring spun yarn comprises at least one optional dye.

16. A knitted fabric of claim 15,
wherein said optional dye is a fluorescent dye.

17. A knitted fabric of claim 1,
wherein said knitted fabric has a basis weight of at least about 7.5 ounces/square yard (OPSY).

18. A knitted fabric of claim 1,
wherein said knitted fabric has a basis weight of at least about 8.0 ounces/square yard (OPSY).

19. A knitted fabric of claim 1,
wherein said knitted fabric has a basis weight of at least about 8.7 ounces/square yard (OPSY).

20. A garment, comprising the knitted fabric of claim 1;
wherein said first portion forms the outside of said garment; and
wherein said second portion forms the inside of said garment.

21. A garment, comprising:
fabric; and
at least one traceable marker memory device in contact with said fabric;
wherein said traceable marker memory device comprises information selected from the group consisting of identity of said garment, time in/out of a user, elapsed time from a triggering event, physiological characteristic of a user, environmental condition of a user, exposure level of a user, service life of said garment, compliance level of said user, and combinations thereof.

22. A garment of claim 21,
wherein said garment is washable.

23. A garment of claim 21,
wherein said traceable marker memory device is passive.

24. A garment of claim 21,
wherein said traceable marker memory device is active.

25. A garment of claim 21,
wherein said traceable marker memory device is attached to a surface of said garment.

26. A garment of claim 21,
wherein said traceable marker memory device is embedded within said fabric.

27. A garment of claim 21,
wherein said traceable marker memory device is an RFID tag, optical code, magnetic code, smart label, a global positioning system (gps) tag, or a combination thereof.

28. A garment of claim 21,
wherein said fabric is fire-resistant.

29. A garment of claim 21,
wherein said fabric is anti-static.

30. A garment of claim 21,
wherein said fabric is anti-ballistic.

31. A garment of claim 22, further comprising:
a sensor.

32. A garment of claim 31,
wherein said sensor measures real-time at least one parameter selected from said global positioning of a user, said physiological characteristic of a user, said environmental condition of a user, said exposure level of a user, and combinations thereof.

33. A garment of claim 32,
wherein said physiological characteristics of a user are selected from the group consisting of body temperature, blood pressure, pulse, respiration, blood sugar level, skin resistance, and combinations thereof.

34. A garment of claim 32,
wherein said environmental condition of a user are selected from the group consisting of temperature, humidity, pressure, sound level, weather, chemical hazard exposure, radiation exposure, biological hazard exposure, electrical hazard, and combinations thereof.

35. A garment of claim 21,
wherein said garment is a shirt, pants, underwear, outerwear, footwear, headwear, swimwear, belt, glove, headband, wristband, or a combination thereof.

36. A system, comprising:
at least one garment of claim 21; and
a detector for said traceable marker memory device.

37. A system, comprising:
at least one garment of claim 21;
a detector for said traceable marker memory device; and
a detector for said sensor.

38. A system of claim 37,
wherein said detector for said traceable marker memory device is portable.

39. A system of claim 36,
wherein said detector for said sensor is portable.

40. A system of claim 36,
wherein said detector for said traceable marker memory device is capable of reading said traceable marker memory device and decoding said traceable marker memory device.

41. A system of claim 36,
wherein said detector for said traceable marker memory device is
an RFID reader,
CCD camera with decoding software,
smart label reader,
a GPS control and monitoring system, or
a combination thereof.

42. A system of claim 36,
further comprising an alert said when garment falls outside of at least one criteria for use of said garment.

43. A method of confirming adherence to a safety, health, or environmental standard of a user of a garment, comprising:
providing at least one garment, comprising:
fabric; and
at, least one traceable marker memory device in contact with said fabric;
wherein said traceable marker comprises information selected from the group consisting of identity of a user, identity of said garment, time in/out of a user, elapsed time from a triggering event, global positioning of a user, physiological characteristic of a user, environmental condition of a user, exposure level of a user, service life of said garment, compliance level of said user, and combinations thereof;
reading said traceable marker to provide usage information; and
determining whether usage information falls outside of at least one criterion for use of said garment.

44. A method of claim 43,
further comprising:
alerting said user that said garment falls outside of at least one criteria for use of said garment.

45. A method of claim 43,
further comprising:
alerting at least one supervisor of said user that said garment falls outside of at least, one criteria for use of said garment.

46. A method of claim 43,
further comprising:
preventing ingress into or egress from a facility.

47. A method of claim 46,
wherein said facility is a chemical plant, a biological manufacturing plant, a waste treatment plant, an oil exploration site, an oil refining site, or a combination thereof.

48. A method of claim 43,
wherein said user is a worker at a chemical, industrial, or oil refining facility, utility worker, firefighter, military personnel, or a combination thereof.
